(19) United States
(12) Patent Application Publication
(10) Pub. No.: US 2001/0011953 A1
(43) Pub. Date: Aug. 9, 2001

(54) CONFIGURABLE REMOTE CONTROL UNIT USING A REMOVABLE MEMORY DEVICE

(76) Inventors: PETER RAE SHINTANI, SAN DIEGO, CA (US); HIROFUMI USUI, POWAY, CA (US)

Correspondence Address: PHILIP M SHAW JR, CROSBY HEAFEY ROACH & MAY, PO BOX 7936, SAN FRANCISCO, CA, 941207936

(21) Appl. No.: 09/130,809

(22) Filed: Aug. 7, 1998

(51) Int. Cl. G05B 19/02; G08C 19/00

(52) U.S. Cl. 340/825.22; 340/825.69; 340/825.72

(57) ABSTRACT

A hand-held control device is disclosed for communicating with and controlling the operation of a remotely located electronic apparatus such as a television, VCR or other device. The control device has a display screen for displaying control functions and information for the operation of the remote electronic apparatus and a transmitter and a receiver for communicating between the remote electronic apparatus and the hand-held control device. A user interface, such as a touchpad or soft keys allows a user to make control selections for operating the remote electronic apparatus. A removable, programmable memory is provided for storing therein control and other format information for a particular electronic apparatus to be operated. The removable memory attaches to the control unit via a port for receiving the removable memory module. A controller responsive to the contents of the removable programmable memory controls the operation of the hand-held control device for controlling the operation of the remote electronic apparatus, in response to user control selections. In the preferred embodiment the removable programmable memory is a flash memory module. The memory module can be programmed by cloning it from another control unit, by an adapter used with a PC, or downloaded from the Internet.

### BACKGROUND OF THE INVENTION

1. Field of the Invention

The present invention relates to hand-held control devices for operating remote electronic equipment such as televisions and VCRs, and in particular to a control device which utilizes a removable, programmable memory device so that it can easily be used with different electric equipment.

2. Related Art

Hand-held control devices have become quite popular for operating and controlling such devices as televisions, VCRs, radios and other electronic equipment. There are several types of such hand-hold control devices currently available. The most basic is a dedicated remote control unit. This type of unit contains the remote codes for only the particular electronic device for which it is intended. It cannot be changed or reprogrammed for any other type of electronic device.

A second type of remote control unit is preprogrammed. A preprogrammed control unit contains a non-volatile memory device which stores the remote control codes for a number of devices which can be accessed via a code number. This allows a single control unit to access a plurality of remote devices, depending upon the access number which is entered. The disadvantage of this type of remote control unit is that it can only support those electrical devices that have their codes pre-stored inside of the control unit's nonvolatile memory. Also, the user interface is set and cannot be changed. The key layout and what each button controls is preset and cannot be altered by the user.

A third type of remote control unit is programmable. Such unit typically contains a photodiode which is used to receive the IR command from another remote control unit. This allows the programmable remote control unit to “learn” the IR commands from another remote control unit. A disadvantage with this type of remote control unit is that the new commands must be programmed in one by one. Sometimes mistakes occur during programming. Another significant disadvantage is that the user must make labels manually for the control functions or else remember where each command was programmed to a specific key.

### SUMMARY OF THE INVENTION

In accordance with the invention, a hand-held control device is provided for communicating with and controlling the operation of a remotely located electronic apparatus such as a television, VCR or the like. The control device has a display screen for displaying control function symbols or icons and other information for the operation of the remote electronic apparatus. Control signals are transmitted from the control device for communicating between the remote electronic apparatus. A user interface, such as a touchpad or soft keys allows a user to make control selections for operating the remote electronic apparatus.

A removable, programmable memory is provided for storing therein control and other format information for a particular electronic apparatus to be operated. The removable memory attaches to the control unit via a port for receiving the removable memory module. A controller responsive to the contents of the removable programmable memory controls the operation of the hand-held control device for controlling the operation of the remote electronic apparatus, in response to user control selections. In the preferred embodiment the removable programmable memory is a flash memory module. The memory module can be programmed by cloning it from another control unit, by an adapter used with a PC, or downloaded from the Internet.

The remote control unit can be implemented with a bit mapped dot matrix display, thus allowing relatively complex symbols or icons to be displayed. This approach allows the control unit to be configured without soft keys, a less expensive alternative user interface. When a removable memory device is inserted into the remote control unit, the current configuration information can be saved. Similarly, if the removable memory device is inserted into an adapter which is connected to a personal computer, the control unit can be programmed independently. It is this ability to be programmed off-line which makes the removable memory device very flexible. A user can program and or customize the user interface of the remote control on a PC, which can offer a personalized programming environment.

Once programmed the contents of a the programmed remote control unit can be transferred to another remote control unit through the ability of cloning the contents of the removable memory device. Also, the partial or full memory contents can be passed to other remote control units via infra-red or other types of signal sources and stored in the removable memory device, making cloning very easy.

The foregoing and other objectives, features and advantages of the invention will be more readily understood upon consideration of the following detailed description of certain preferred embodiments of the invention, taken in conjunction with the accompanying drawings.

### BRIEF DESCRIPTION OF THE DRAWINGS

FIG. 1 is a block schematic diagram of the hand-held remote control unit of the present invention, utilizing a removable, programmable memory module.

FIG. 2 is a more detailed block schematic diagram of the hand-held remote control unit of FIG. 1.

FIG. 3A is a side view of a touchpad which can be used as the user interface for the control unit of the present invention; and FIG. 3B is an exploded, perspective view of the touchpad of FIG. 3A.

FIG. 4 illustrates the display on the hand-held remote control unit after being programmed by the removable memory module.

FIG. 5 illustrates the use of soft keys as an alternative user interface.

FIG. 6 shows the use of a personal computer (PC) as one device to program the removable memory.

### DETAILED DESCRIPTION OF THE PREFERRED EMBODIMENT

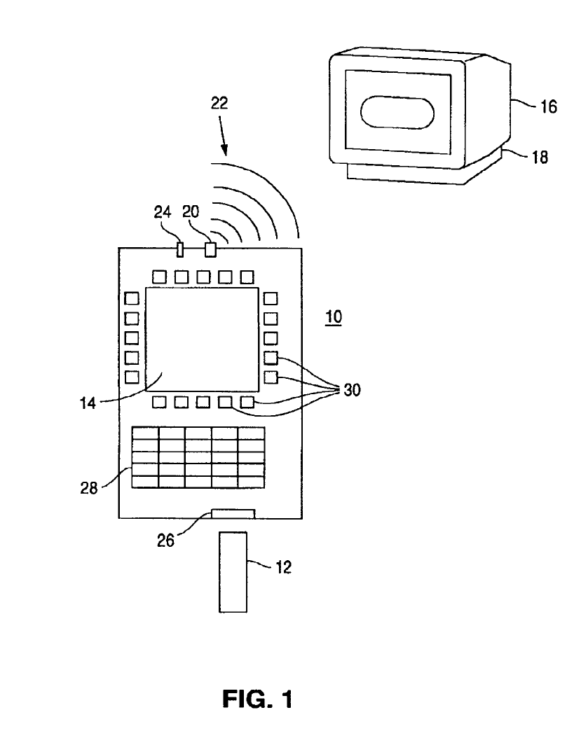

FIG. 1 is a block schematic diagram of the hand-held remote control unit 10 of the present invention, utilizing a removable, programmable memory module 12. Remote control unit 10 has a display screen 14 for displaying control symbols or icons used by the user to control a remote electrical or electronic apparatus such as a television 16 and a VCR 18. While a television and VCR are used as illustrative examples of remotely operated electronic apparatus, it should be understood that the present invention is applicable to other electrical or electronic apparatus such as radios, remotely operated toys, computing devices, domestic appliances and the like.

Display screen 14 can be a conventional LCD screen. A dot matrix LCD screen is preferable so that the displays can be bit mapped in the conventional manner to display detailed symbols and icons and the like. Signals are sent from control unit 10 to television 16 and VCR 18 in the conventional manner from an IR emitter which sends out infrared signals 22 which are received by the television and VCR and appropriate control actions are taken, in accordance with the user's desires. An IR photodiode 24 can also be provided with control unit 10. Photodiode 24 allows return information signals from the electrical apparatus under remote control. Also, as will be explained later, the control unit 10 can be programmed directly from the remote electrical device through information sent via IR signals to the control unit. Other forms of signals can be used to communicate between the control unit and the remote electrical apparatus such as RF and ultra-sonic signals, or any combination of these signals.

In FIG. 1, the user interface is provided by through a conventional keyboard 28 and a plurality of “soft keys” 30. Soft keys are so-called because they are not dedicated to a particular function. The function performed by each soft key 30 is dictated by information displayed adjacent each soft key on the screen 14, as explained in greater detail later.

The programmable memory module 12 is inserted within a port 26 of control unit 10. Removable memory module 12 is programmed according to the particular electrical apparatus to be controlled, in this case television 16 and VCR 18. A user may remove the memory module 12 and insert it in another hand-held control unit. Alternately, the contents in memory 12 can be copied to another programmable memory module, for use with another control unit 10. The programmed contents of the control unit can be passed to another remote control unit via infra-red and then stored in the removable memory device. This permits easy cloning of the remote control unit. If a user replaces his/her television and VCR with another model, the memory module can be re-programmed for the new model.

The preferred programmable memory module 12 is a flash memory. Flash memory is a well-known and has the characteristics that it is non-volatile and also programmable. Several companies make a version of flash memory that is suitable for the present application. One product is called “CompactFlash” and was developed by SanDisk Corp. Another product, made for digital cameras is called “SmartMedia” and is sold by Microtech Corp. Such flash memory cards are available with storage of up to 80 MB, which provides adequate storage for the present invention. Another product is sold under the trademark “Mobility”, and the product is called the “PCMCIA CompactFlash Card”.

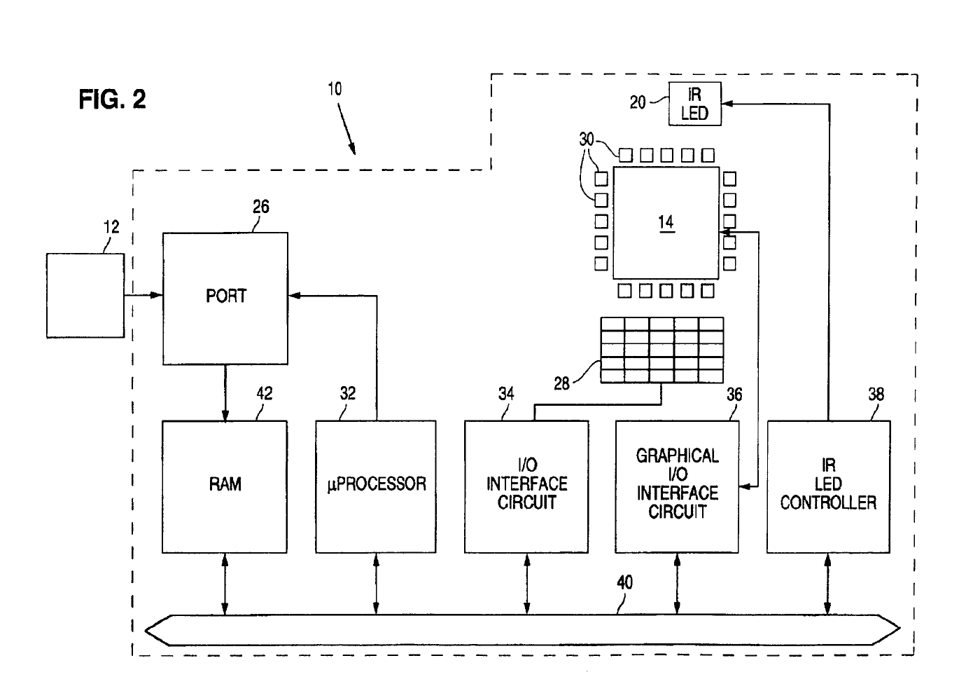

FIG. 2 is a more detailed block schematic diagram of the hand-held remote control unit 10 of FIG. 1. A microprocessor 32, I/O interface circuit 34, graphical I/O interface circuit 38 and IR LED controller 38 are all coupled by bus 40. Also coupled to bus 40 is the control unit's RAM 42 for storing program codes. The program codes, which define format and control function information from the removable memory module 12, is down-loaded at the port 26 and stored in RAM 42. The microprocessor 32 controls the operations of the I/O interface circuits 34 and 36 as well as the IR LED controller 38. It also controls the down-loading of information from the memory module 12 to RAM 42. The processor executes the program codes stored in RAM 42 to display control functions on display screen 14, and to act on user commands to send appropriate control signals to the television 16 and VCR 18. By loading different program codes from memory module 12, microprocessor 32 displays different control functions on display screen 14 and generates different control signals to control a different model of television and VCR, or a different type of electric equipment.

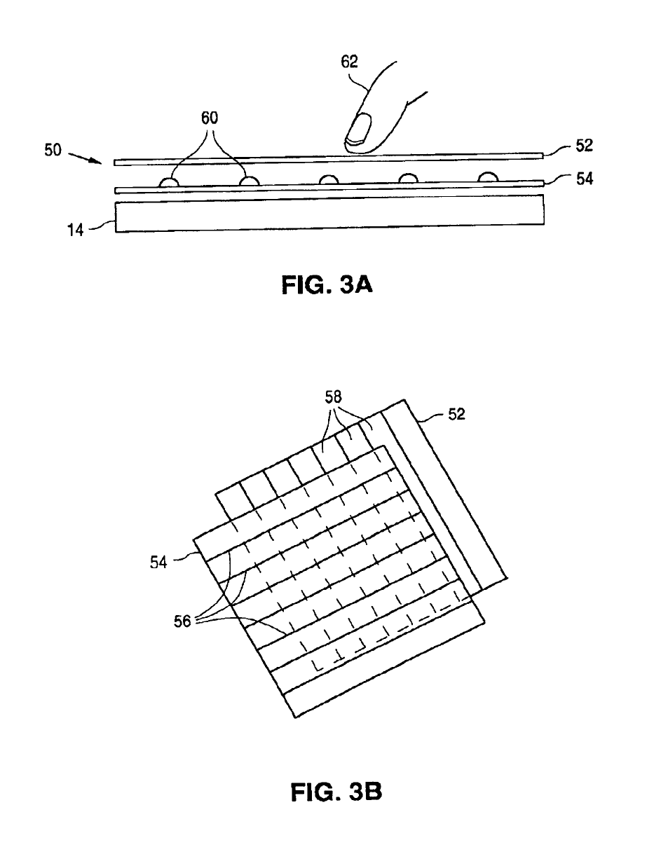

FIG. 3A is a side view of a touchpad 50 which can be used as the user interface for the control unit 10 of the present invention; and FIG. 3B is an exploded, perspective view of the touchpad 50 of FIG. 3A. Touchpad 50 is placed on top of LCD panel, which can be back lighted. Touchpads are well known and typically have two layers 52 and 54. Layer 52, for example, has a horizontal or X array of conductors 56 and layer 54 has a vertical or Y array of conductors 58. The two arrays of conductors are orthogonal to each other and are normally separated by spacers 60. When a user's finger 60 or other stylus presses down on the touchpad where a desired control function is displayed on screen 14, a connection of the X and Y conductors at that location takes place providing information to the microprocessor as to the desired control function by the user.

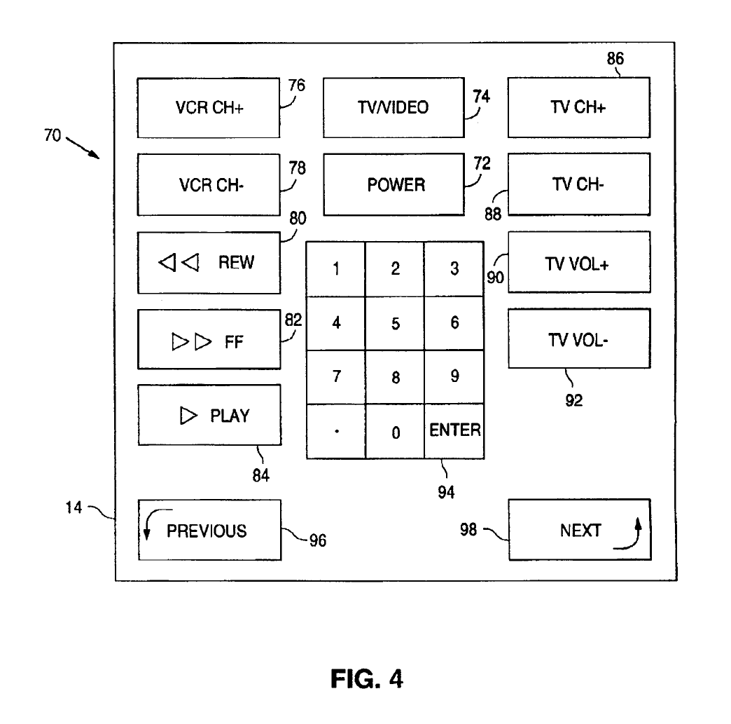

FIG. 4 illustrates a typical display 70 as seen on the screen 14 of the hand-held remote control unit after being programmed by the removable memory module. Of course the display can be configured in any desired manner. In this example, a power icon 72 is displayed to turn the TV/VCR on and off. Television/Video icon 74 is used to chose the mode of operation. Icons 76 and 78 are displayed to increment or decrement the VCR channel, respectively. Icons 80, 82, and 84 are for rewind, fast forward, and play, respectively, for the VCR. The television channels can be changed incrementally by icon 86 and decrementally by icon 88. The television channels can also be changed by matrix 94. Volume level icons 90 and 92 control the television volume. The user can see the previously displayed screen by using icon 96 or the next screen by using icon 98. As explained above, with the use of a touchpad, the user merely touches the desired command to control the remote TV/VCR.

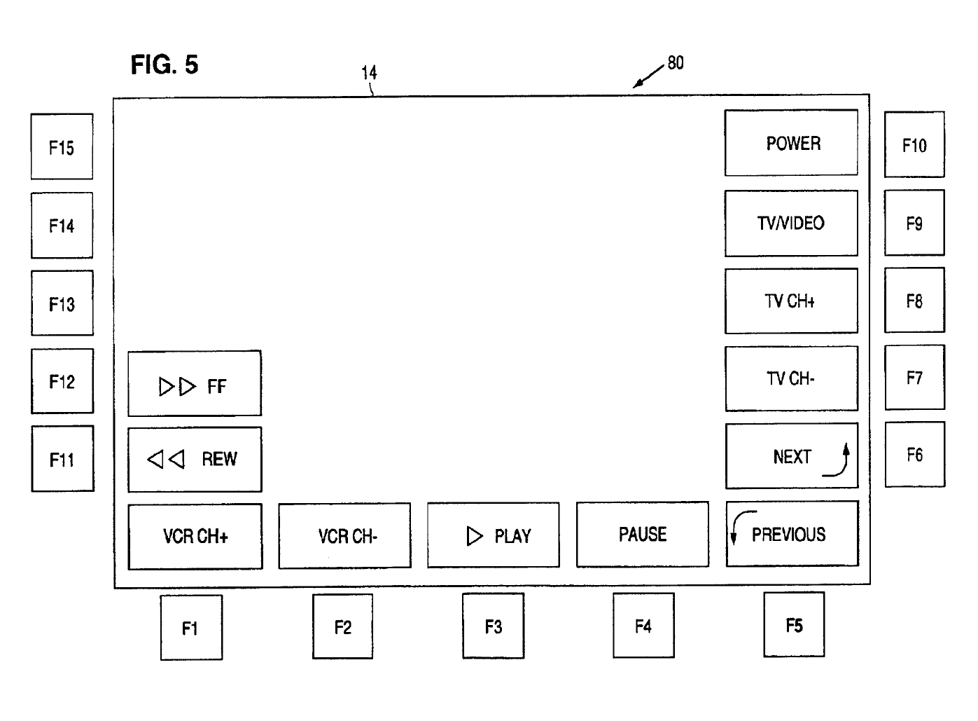

FIG. 5 illustrates the use of soft keys as an alternative user interface. A similar display 80 of control functions is provided on screen 14, is provided as in FIG. 4. However, instead of a touchscreen over the function symbols displayed on screen 14, soft keys F1-F12 are used. The corresponding function description for a given soft key is displayed next to the soft key on the display screen 14. For example, the user hits the soft key F10 to turn on the remote device. Soft key F8 is used to increment the TV channel, and F7 to decrement it, and so forth. In response to a user's selection of a particular soft key, microprocessor 32 executes the program codes stored in RAM 42 to generate control signals to remotely control television 16 and VCR 18.

It should be appreciated that by loading different program codes from programmable memory module 12, microprocessor 32 can execute the newly loaded program codes to display new function descriptions for soft keys F1 -F12. In response to the selections of the same soft Keyes F1 -F12, microprocessor 32 executes the new program codes to generate different control signals to remotely control a different model of television and VCR, or a different type of electronic equipment.

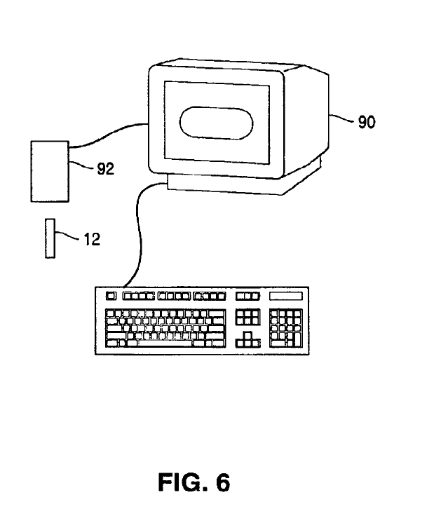

FIG. 6 shows the use of a personal computer (PC) 90 as one device to program the removable memory 12. An adapter 92 is provided to accept the memory module 12. The adapter 96 contains a memory writing control circuitry to write program codes stored in PC 90 into memory 12.

The present invention eliminates the necessity of physically labeling controls for different model or different type of electric equipments, thus reducing the manufacturing costs and increasing manufacture flexibility. Icons and soft key labels can be created either on the remote control unit 10 or by PC 90. With the increased resolution and speed of a PC, it is a simple task to use the graphic I/O interface circuit 36 (FIG. 2) to create any desired icons and soft key labels. Users can create their own personal interface for their remote control devices, if they wish. The PC 90 can serve as an editing tool and the newly created or edited user configurations information and codes can be written in the removable memory device 12.

Since many PCs are connected to networks or have access to many websites, commands can be downloaded from a manufacturer's home page. This would eliminate the need for manually programming a programmable control unit. It would provide a high degree of accuracy of the programming process since the exact timing and carrier frequency information can be transferred digitally to the removable memory device.

Although the present invention has been shown and described with respect to preferred embodiments, various changes and modifications are deemed to lie within the spirit and scope of the invention as claimed. The corresponding structures, materials, acts, and equivalents of all means or step plus function elements in the claims which follow are intended to include any structure, material, or acts for performing the functions in combination with other claimed elements as specifically claimed.

What is claimed is:

1. A control device for communicating with and controlling the operation of a remotely located electronic apparatus comprising:
a user interface for allowing a user to make control selections for operating the remote electronic apparatus;
a display screen for displaying control functions for the user interface;
a removable, programmable memory for storing therein control information for a particular electronic apparatus to be operated;
a controller, responsive to the contents of the removable programmable memory, for generating control signals to operate the control device for controlling the operation of the remote electronic apparatus, in response to user control selections from the user interface; and
a transmitter for transmitting the control signals from the control device to the remote electronic apparatus.

2. A control device as in claim 1 wherein the removable programmable memory is a flash memory module.

3. A control device as in claim 1 wherein the display screen is a liquid crystal display screen.

4. A control device as in claim 3 wherein the information displayed on the liquid crystal display screen is bit-mapped.

5. A control device as in claim 3 wherein the user interface comprises a touchpad over the display screen.

6. A control device as in claim 1 wherein the user interface comprises soft keys adjacent the display screen.

7. A system for programming a control device for communicating with and controlling the operation of a remotely located electronic apparatus comprising:
a user interface for allowing a user to make control selections for operating the remote electronic apparatus;
a display screen for displaying control functions for the user interface;
a removable, programmable memory for storing therein control information for a particular electronic apparatus to be operated;
a controller, responsive to the contents of the removable programmable memory, for generating control signals to operate the control device for controlling the operation of the remote electronic apparatus, in response to user control selections from the user interface;
a transmitter and a receiver for transmitting control signals from the control device to the remote electronic apparatus; and
a personal computer having a circuit for writing the control information into the removable programmable memory for a particular remote electronic apparatus.

8. The system of claim 7 wherein the personal computer has access to the Internet and control information is downloaded therefrom to program the removable programmable memory.

9. A system for programming a control device for communicating with and controlling the operation of a remotely located electronic apparatus comprising:
a user interface for allowing a user to make control selections for operating the remote electronic apparatus;
a display screen for displaying control functions for the operation of the remote electronic apparatus;
a removable, programmable memory for storing therein control information for a particular electronic apparatus to be operated;
a controller, responsive to the contents of the removable programmable memory, for generating control signals to operate control device for controlling the operation of the remote electronic apparatus, in response to user control selections from the user interface;
a transmitter for transmitting the control signals from the control device to the remote electronic apparatus; and
means associated with the electronic apparatus to be controlled to transmit control information to load the removable programmable memory for operation of the control device.

10. A method for communicating with and controlling the operation of a remotely located electronic apparatus comprising the steps of:
making control selections for operating the remote electronic apparatus from a user interface;
displaying control functions on a display screen for the user interface;
storing therein control information for a particular electronic apparatus to be operated in a removable, programmable memory;
responsive to the contents of the removable programmable memory, generating control signals to operate the control device for controlling the operation of the remote electronic apparatus, in response to the control selections from the user interface; and
transmitting the control signals to the remote electronic apparatus.

11. A method as in claim 10 wherein the removable programmable memory is a flash memory module.

12. A method as in claim 10 wherein the display screen is a liquid crystal display screen.

13. A method as in claim 12 wherein the information displayed on the liquid crystal display screen is bit-mapped.

14. A method as in claim 12 wherein the user interface comprises a touchpad over the display screen.

15. A method as in claim 10 wherein the user interface comprises soft keys adjacent the display screen.

16. A method for programming a control device for communicating with and controlling the operation of a remotely located electronic, comprising the steps of:
making control selections for operating the remote electronic apparatus from a user interface;
displaying control functions on a display screen for the user interface;
storing therein control information for a particular electronic apparatus to be operated in a removable, programmable memory;
responsive to the contents of the removable programmable memory, generating control signals to operate the control device for controlling the operation of the remote electronic apparatus, in response to user control selections from the user interface;
transmitting control signals from the control device to the remote electronic apparatus; and
at a personal computer, writing the control information into the removable programmable memory for a particular remote electronic apparatus.

17. The method of claim 16 wherein the personal computer has access to the Internet and control information is downloaded therefrom to program the removable programmable memory.

18. A method for programming a control device for communicating with and controlling the operation of a remotely located electronic apparatus, comprising the steps of:
making control selections for operating the remote electronic apparatus from a user interface;
displaying control functions on a display screen for the operation of the remote electronic apparatus;
storing therein control information for a particular electronic apparatus to be operated in a removable, programmable memory;
responsive to the contents of the removable programmable memory, generating control signals to operate control device for controlling the operation of the remote electronic apparatus, in response to user control selections from the user interface;
transmitting the control signals from the control device to the remote electronic apparatus; and
from means associated with the electronic apparatus to be controlled, transmitting control information to load the removable programmable memory for operation of the control device.
